(19) United States
(12) Patent Application Publication
(10) Pub. No.: US 2006/0058009 A1
(43) Pub. Date: Mar. 16, 2006

(54) System and method for wireless download capability of media objects from multiple sources

(76) Inventors: Jerome O. Vogedes, Wind Lake, WI (US); Kevin C. Mowry, Irving, TX (US)

Correspondence Address: MOTOROLA INC, 600 NORTH US HIGHWAY 45, ROOM AS437, LIBERTYVILLE, IL, 60048-5343, US

(21) Appl. No.: 10/941,538

(22) Filed: Sep. 15, 2004

(51) Int. Cl. H04M 3/16

(52) U.S. Cl. 455/412.1; 455/575.1

(57) ABSTRACT

A wireless communication system (100) capable downloading media objects (336) to a mobile device (102) from content sources (104, 106, 108) is provided. At least one server (300) includes a memory (306) that stores a download descriptor (334), associated with a media object (336), which includes multiple server identifiers (408, 410, 412), and a network interface (302) that transmits to the mobile device (102), via a wireless communication link, the download descriptor (334). The mobile device (102) has a wireless transceiver (202) that receives the download descriptor (334) and a processor (304) that selects a particular server identifier of the multiple server identifiers (408, 410, 412). The wireless transceiver (202) of the mobile device (102) retrieves the media object (336) from a server associated with the particular server identifier.

### FIELD OF THE INVENTION

The present invention relates generally to the field of electronic systems that permit communication of generic content from one device to another. In particular, the present invention is directed to wireless communication networks and methods providing the capability of downloading media objects over-the-air from servers to mobile communication devices.

### BACKGROUND OF THE INVENTION

Wireless communication networks provide content delivery functionality, including content download, so that various types of content may be available to mobile users. For content delivery, a media object is delivered from a download server to a mobile device over a communication network that includes one or more wireless links. Once received, the mobile device processes the media object by performing operations such as installation and execution of the content. Delivery of the media object is typically performed based on a standard protocol utilized by the server and the mobile device.

A server's capability for content delivery to one or more mobile devices may vary based one the server's capacity to deal with its existing demand for service. For example, a server may become overloaded due to peaks in traffic or otherwise incapable of providing acceptable service to a mobile device. Also, capabilities of content deliver often vary from server to server. In relation to wired communication systems, the problems associated with a server inability to provide service are magnified for mobile devices due to the limited bandwidth and/or higher cost associated with wireless communication systems. Thus, each time a mobile device communicates with a server, the mobile device must hope that the server is currently capable of providing acceptable service.

There is a need for a system and method that maximizes a mobile device's opportunity to access a server that is currently capable of providing acceptable service. By increasing the chances of accessing an acceptable server, the mobile device decreases its chance of being subjected to problems or otherwise unacceptable service.

### BRIEF DESCRIPTION OF THE DRAWINGS

FIG. 1 is a diagrammatic view representing preferred embodiments of a system in accordance with the present invention.

FIG. 2 is a block diagram representing an exemplary mobile device of the mobile device shown in FIG. 1 in accordance with the present invention.

FIG. 3 is a block diagram representing an exemplary server of the servers shown in FIG. 1 in accordance with the present invention.

FIG. 4 is a block diagram of an exemplary data structure for the descriptor communicated between a server and a mobile device, such as the ones shown in FIG. 1, in accordance with the present invention.

FIG. 5 is an exemplary code format of the exemplary data structure for the descriptor represented by FIG. 4.

FIG. 6 is a flow diagram representing preferred operations of the system shown in FIG. 1 in accordance with the present invention.

### DETAILED DESCRIPTION OF THE PREFERRED EMBODIMENTS

The present invention is a system and method for maximizing a mobile device's opportunity to access an acceptable server for over-the-air downloads by providing opportunities to multiple servers for over-the-air downloads when preferred servers are not available. If multiple servers are available, a user may select one particular server that provides optimal download capabilities (such as the fastest or most reliable download capability) or select an alternative server. For example, the system and method provides a mobile device with the capability of selecting a different or alternate server if a preferred server is not available. The available servers are identified for the mobile device by a descriptor that is provided by a server or proxy. The mobile device may initiate a download from a server based on an identifier, such as a universal resource identifier (“URI”) or a universal resource locator (“URL”), in the descriptor.

One aspect of the present invention is a mobile device for communicating wirelessly with content sources having access to media objects comprising a wireless transceiver and a processor. The wireless transceiver is configured to receive a download descriptor associated with a media object in which the download descriptor includes multiple server identifiers. The processor is configured to select a particular server identifier of the multiple server identifiers received by the wireless transceiver. The wireless transceiver retrieves the media object from a server associated with the particular server identifier.

Another aspect of the present invention is a wireless communication system capable downloading media objects to a mobile device from content sources comprising one or more servers. At least one server includes a memory configured to store a download descriptor associated with a media object in which the download descriptor includes multiple server identifiers, and a network interface configured to transmit to the mobile device, via a wireless communication link, the download descriptor.

Yet another aspect of the present invention is a method of a mobile device for communicating wirelessly with content sources having access to media objects. The mobile device ascertains, via a wireless communication link, a download descriptor associated with a media object in which the download descriptor includes multiple server identifiers. The mobile device then selects a particular server identifier of the multiple server identifiers. Thereafter, the mobile device retrieves, via the wireless communication link, the media object from a server associated with the particular server identifier.

Still another aspect of the present invention is a method of one or more servers having access to media objects for communicating wirelessly with a mobile device. A server transmits to the mobile device, via a wireless communication link, a download descriptor associated with a media object in which the download descriptor includes multiple server identifiers. The same server, or a different server, then receives, via the wireless communication link, a selection of a particular server identifier of the multiple server identifiers. Thereafter, the server that receives the selection delivers, via the wireless communication link, the media object from a server associated with the particular server identifier.

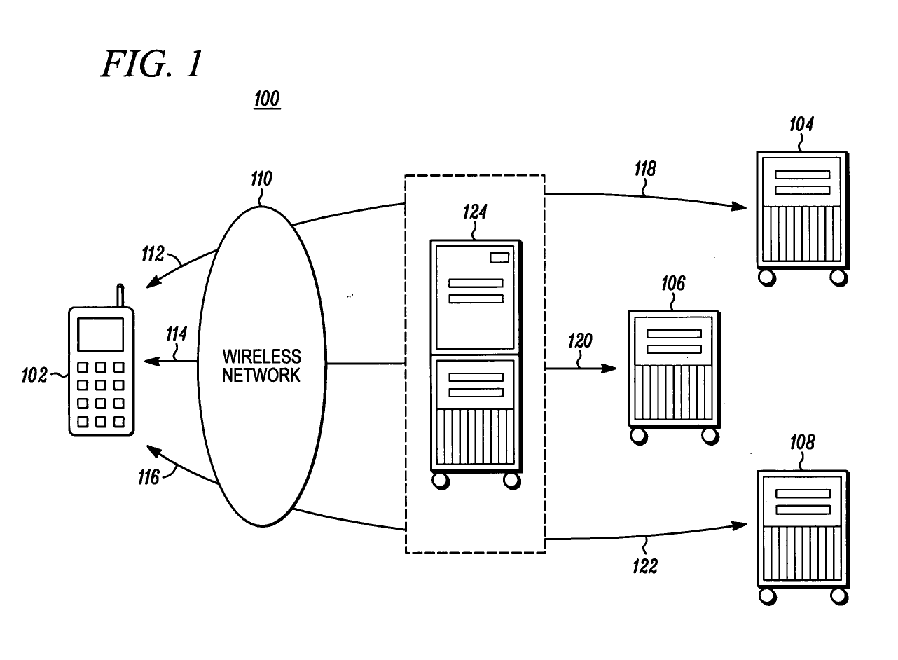

Referring to FIG. 1, a wireless communication system 100 in accordance with the present invention comprises a mobile device 102 communicating with multiple servers 104, 106, 108 via a wireless network 110. The mobile device 102 communicates with the wireless network 110 via wireless connections 112, 114, 116, and the wireless network communicates with the servers 104, 106, 108 via network connections 118, 120, 122. Wireless communication links or connections utilized by the wireless network 110 include, but are not limited to, cellular-based communications such as analog communications (using AMPS), digital communications (using CDMA, TDMA, GSM, iDEN, GPRS, or EDGE), and next generation communications (using UMTS or WCDMA) and their variants; a peer-to-peer or ad hoc communications such as HomeRF, Bluetooth and IEEE 802.11(a, b or g); and other forms of wireless communication such as infrared technology.

The wireless communication system 100 may also comprise an intervening server or proxy 124 for managing communications and/or transactions between the mobile device 102 and the servers 104, 106, 108. For example, the servers 104, 106, 108 may include media objects that are of interest to the mobile device 102, and the proxy 124 may facilitate over-the-air downloading of one or more media objects from a particular server to the mobile device. For one embodiment, the proxy 124 may provides a download descriptor associated with a media object, which includes a plurality of server identifiers, to the mobile device 102, so that the mobile device may select a particular server identifier and retrieve the media object from the selected server corresponding to the particular server identifier. The media object may be retrieved by the mobile device 102 directly from the selected server of indirectly from the selected server via the proxy 124.

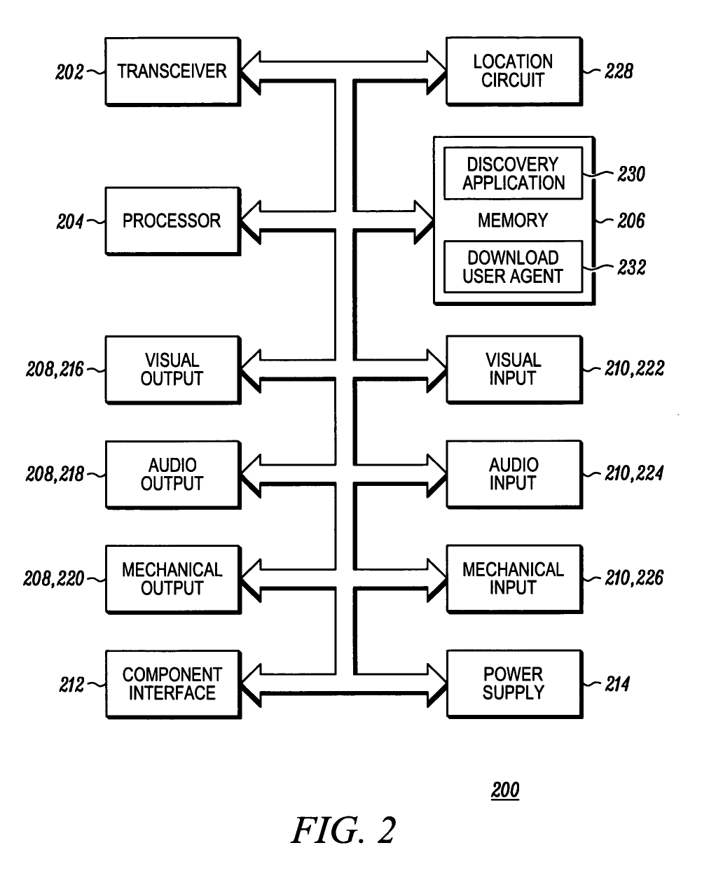

Referring to FIG. 2, there is provided a block diagram illustrating exemplary internal components 200 of a mobile device in accordance with the present invention. The exemplary embodiment includes one or more wireless transceivers 202, a processor 204, a memory portion 206, one or more output devices 208, and one or more input devices 210. Each embodiment may include a user interface that comprises one or more output devices 208 and one or more input device 210. Each transceiver 202 may utilize wireless technology for communication, such as the wireless communication links or connections described above. The internal components 200 may further include a component interface 212 to provide a direct connection to auxiliary components or accessories for additional or enhanced functionality. The internal components 200 preferably include a power supply 214, such as a battery, for providing power to the other internal components while enabling the mobile device 102 to be portable.

An exemplary function of the wireless communication device 102 as represented by the internal components 200, upon reception of wireless signals, the internal components detect communication signals and the transceiver 202 demodulates the communication signals to recover incoming information, such as voice and/or data, transmitted by the wireless signals. After receiving the incoming information from the transceiver 202, the processor 204 formats the incoming information for one or more output devices 208. Likewise, for transmission of wireless signals, the processor 204 formats outgoing information, which may or may not be activated by the input devices 210, and conveys the outgoing information to the transceiver 202 for modulation to communication signals. The transceiver 202 conveys the modulated signals to a remote device, such as servers 104, 106, 108, 124.

The input and output devices 208, 210 of the internal components 200 may include a variety of visual, audio and/or mechanical outputs. For example, the output device(s) 208 may include a visual output device 216 such as a liquid crystal display and light emitting diode indicator, an audio output device 218 such as a speaker, alarm and/or buzzer, and/or a mechanical output device 220 such as a vibrating mechanism. Likewise, by example, the input devices 210 may include a visual input device 222 such as an optical sensor (for example, a camera), an audio input device 224 such as a microphone, and a mechanical input device 226 such as a flip sensor, keyboard, keypad, selection button, touch pad, touch screen, capacitive sensor, motion sensor, and switch. Actions that may actuate one or more input devices 210 include, but not limited to, opening the wireless communication device, unlocking the device, moving the device to actuate a motion, moving the device to actuate a location positioning system, and operating the device.

The internal components 200 of the mobile device 102 may include a location circuit 228. Examples of the location circuit 228 include, but are not limited to, a Global Positioning System (GPS) receiver, a triangulation receiver, an accelerometer, a gyroscope, or any other information collecting device that may identify a current location of the device.

The memory portion 206 of the internal components 200 may be used by the processor 204 to store and retrieve data. The data that may be stored by the memory portion 206 include, but is not limited to, operating systems, applications, and data. Each operating system includes executable code that controls basic functions of the communication device, such as interaction among the components of the internal components 200, communication with external devices via the transceiver 202 and/or the component interface 212, and storage and retrieval of applications and data to and from the memory portion 206. Each application includes executable code utilizes an operating system to provide more specific functionality for the communication device, such as file system service and handling of protected and unprotected data stored in the memory portion 206. Examples of the applications include a discovery application 230 for discovering media on behalf of a user and his/her mobile device and a download user agent 232 responsible for downloading the media object described by the download descriptor. Data is non-executable code or information that may be referenced and/or manipulated by an operating system or application for performing functions of the communication device.

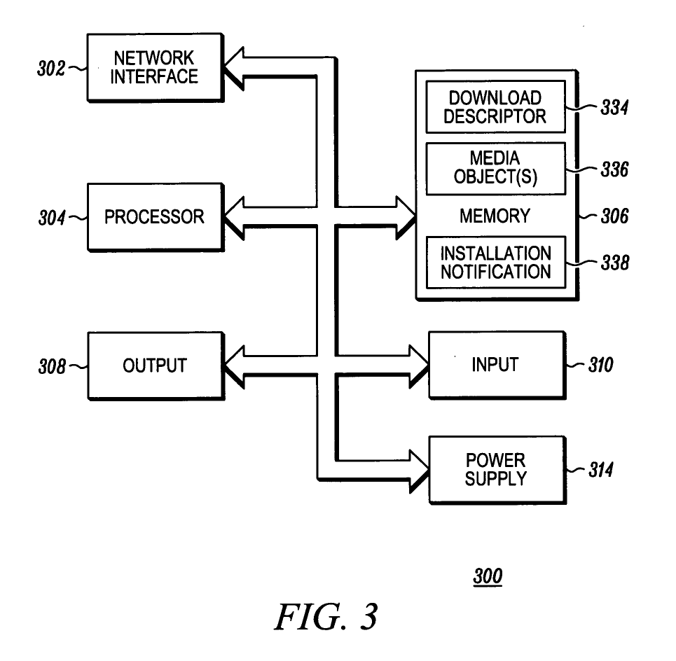

Referring to FIG. 3, there is provided a block diagram illustrating exemplary internal components 300 of a server, such as the servers 104, 106, 108, 124 of FIG. 1, in accordance with the present invention. The exemplary embodiment includes one or more network interfaces 302, a processor 304, a memory portion 306, one or more output devices 308, and one or more input devices 310. Each embodiment may include a user interface that comprises one or more output devices 308 and one or more input device 310. Each transceiver 302 may be a wired transceiver, such as an Ethernet connection, or a wireless connection utilizing wireless technology for communication, such as the wireless communication links or connections described above. The internal components 300 preferably include a power supply 314 for providing power to the other internal components.

The memory portion 306 of the internal components 300 may be used by the processor 304 to store and retrieve data. The data that may be stored by the memory portion 306 include, but is not limited to, operating systems, applications, and data. Each operating system includes executable code that controls basic functions of the communication device, such as interaction among the components of the internal components 300, communication with external devices via the transceiver 302 and/or the component interface 312, and storage and retrieval of applications and data to and from the memory portion 306. Each application includes executable code utilizes an operating system to provide more specific functionality for the communication device, such as file system service and handling of protected and unprotected data stored in the memory portion 306. Data is non-executable code or information that may be referenced and/or manipulated by an operating system or application for performing functions of the communication device. Examples of the data include one or more download descriptors 334, one or more media objects 336, and an installation notification 338. Each download descriptor 334 includes metadata about an associated media object 336, instructions for the download user agent 232 of the mobile device 102 for downloading the media object, and multiple server identifiers each identifying a content source, i.e., download server, that may provide the media object. Each media object 336 is a resource, e.g., a single object or a container of multiple objects, on one or more servers that may be downloaded to the mobile device 102. Each installation notification 338 is a status report message indicating to a server, 104, 106, 108 and/or 124, that the download user agent 232 of the mobile device 102 has successfully installed a particular media object 336 to the mobile device.

In reference to FIGS. 2 and 3, the processors 204, 304 may perform various operations to store, manipulate and retrieve information in the memory portions 206, 306. Each component of the internal components 200, 300 is not limited to a single component but represents functions that may be performed by a single component or multiple cooperative components, such as a central processing unit operating in conjunction with a digital signal processor and one or more input/output processors. Likewise, two or more components of the internal components 200, 300 may be combined or integrated so long as the functions of these components may be performed by the communication device.

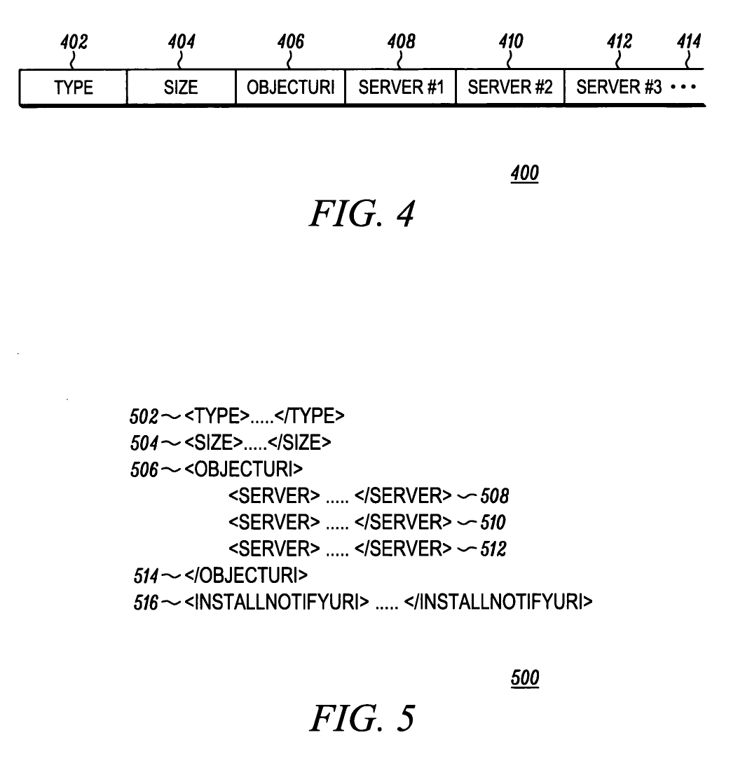

Referring to FIG. 4, there is provided a block diagram of an exemplary data structure 400 for the download descriptor 334 communicated between the mobile device 102 and a server, such as the servers 104, 106, 108, 124. As stated above, each descriptor 334 includes metadata about an associated media object 336, instructions for the download user agent 232 of the mobile device 102 for downloading the media object, and multiple server identifiers each identifying a content source, i.e., download server, that may provide the media object. Thus, the descriptor 334 includes a list of download servers for a given piece of content, i.e., a media object, so that the mobile device 102 may make decisions based on the list of download servers.

The download descriptor 334 includes attributes that describe the media object at a particular location, e.g., at a URI or URL. Some attributes are mandatory and must be included in a valid download descriptor, whereas other attributes are optional and may be included in the download descriptor. Examples of mandatory attributes includes a TYPE attribute 402 which identifies the media type of the media object, a SIZE attribute 404 which identifies the number of bytes to be downloaded from a URI, and an ObjectURI attribute 406 which identifies the URI (usually URL) from which the media object may be loaded. The ObjectURI attribute 406 is particularly important for the download user agent 232 of the mobile device 102, because the download user agent references this attribute to determine the content source of the media object of interest. Although the ObjectURI attribute 406 may identify only one content source, the ObjectURI attribute 406 must include multiple server identifiers to identify multiple content source, i.e., multiple download servers, which may provide the media object in order to benefit from the advantages of the present invention. As described above, the download descriptor 334 may include other attributes 414, which may be mandatory or optional.

Referring to FIG. 5, there is provided an exemplary code format 500 of the exemplary data structure 400 for the download descriptor 334. This exemplary code format 500 is provided in a markup language format, such as HTML, XML and WML; however, it is to be understood that the download descriptor 334 may be implemented based on our formats and/or protocols so long as they are support by the mobile device 102 and one or more of the servers 104, 106, 108, 124. For this example, the TYPE attribute 402 is represented by a first line 502 of the code format 500 in which <type> and </type> surround the media type of the media object 336, and the SIZE attribute 404 is represented by a second line 504 of the code format in which <size> and </size> surround the size of the media object to be downloaded.

The objectURI attribute 406 is represented by a third through seventh line 506-514 of the code format 500 in which <objectURI> and </objectURI> surround the locations of the media object 336 to be downloaded. Each of fourth, fifth and sixth lines 508, 510, 512 of the code format 500 represents a single server of the multiple servers identified within the objectURI attribute. For each of the fourth, fifth and sixth lines 508, 510, 512, a server attribute 408, 410, 412, such as <server> and </server> surrounds a location of the media object 336 to be downloaded for each server. According, multiple server attributes 408, 410, 412 are nested within the objectURI attribute 406 of the example shown in FIG. 5. The example shown in FIG. 5 shows three server attributes 408, 410, 412 nested within the objectURI attribute 406, but it is to be understood that any number of server attributes may be nested within the objectURI attribute.

By way of example, the exemplary code format 500 also shows an InstallNotifyURI attribute which is an optional attribute that may be included in the download descriptor 334. For this particular attribute, support of the functionality of this attribute is mandatory in the download user agent 232, but other optional attribute may note require such support in the download user agent. The InstallNotifyURI attribute 402 is represented by an eighth line 516 of the code format 500 in which <InstallNotifyURI> and </InstallNotifyURI> surround a location to which an installation report, whether successful or not, is to be sent.

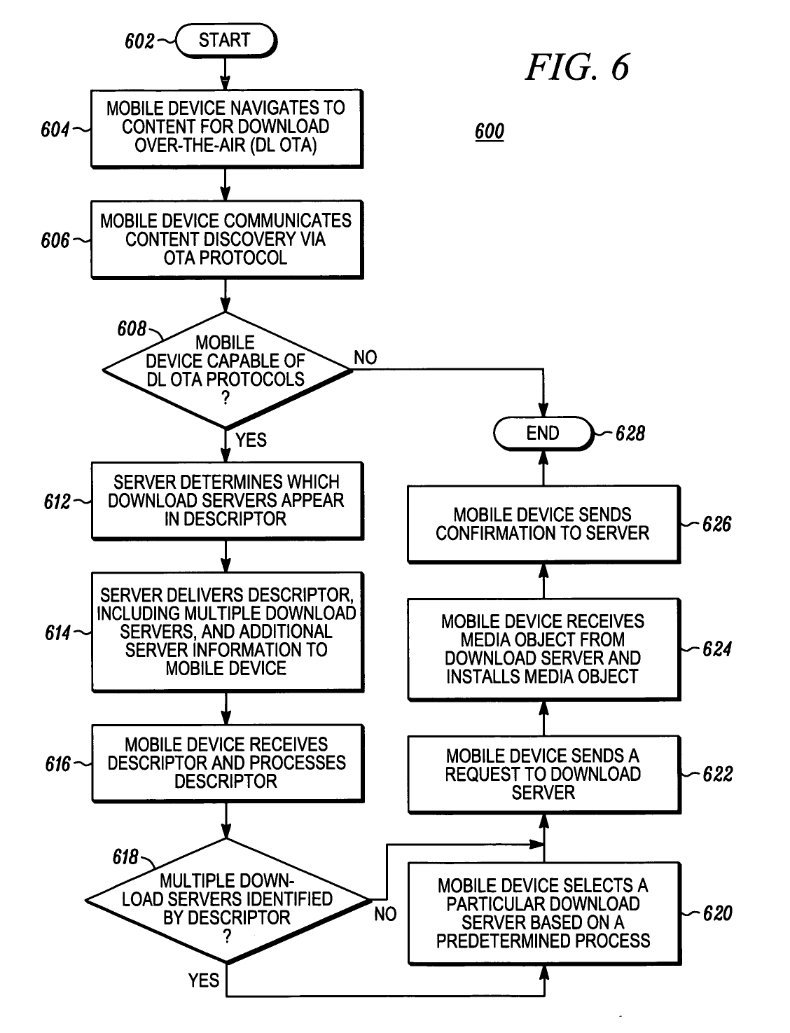

Referring to FIG. 6, there is provided a flow diagram representing preferred operations 600 of the system 100. The preferred operations 600 begin at step 602 and, then, the mobile device 102 finds a resource, i.e., content or media object, that may be loaded into its memory portion 206. The mobile device 102 identifies a download service provided by one or more of the servers 104, 106, 108, at step 604. For example, the mobile station 102 may navigate to content using a browser application, a dedicated discovery application, a received message or an offline means for content that may be downloaded over-the-air (“DL OTA”). After identifying the download service, the mobile device 102 may communicate content discovery using DL OTA protocol at step 606. Next, a central download server, such as one of servers 104, 106, 108 or proxy 124, may determine whether the mobile device 102 is capable of operating with the DL OTA protocol at step 608. If the central download server 104, 106, 108, 124, is not capable of operating with the DL OTA protocol, then the preferred operations 600 terminate at step 628.

If the central download server 104, 106, 108, 124, is capable of operating with the DL OTA protocol, then the central download server may optionally determine which download servers appear in the descriptor 334 at step 612, particularly if the central download server is the proxy 124. Whether or not this determination is made, the central download server 104, 106, 108, 124, delivers the descriptor 334, which includes multiple download servers associated with the content or media object of interest, to the mobile device 102 at step 614. The mobile device 102 receives the descriptor 334 and, in response, processes the descriptor at step 616.

In processing the descriptor, the mobile device 102 determines whether multiple download servers, such as servers 104, 106, 108, are identified by the descriptor 334 at step 618. If multiple download servers are identified by the descriptor 334, then the mobile device 102 selects a particular download server based on a predetermined process at step 620. Examples of such predetermined processes include, but are not limited to, selecting a server based on a location of the mobile device 102, selecting a server based on the mobile network used to communicate between the server and the mobile device, selecting a server based on a user decision or input, and selecting a server based on preset instructions. An example of a user decision or input includes receiving a preference from a user of the mobile device 102 that one server is preferable over the other servers. An example of a preset instruction includes a process that matches the list of download servers to a pre-loaded loaded list of servers or a process that cycles through the list of download servers one-by-one. Thereafter, the mobile device 102 sends a request to the central download server or the selected download server, if different from the central download server, for content delivery at step 622. If, back at step 618, only one download server is identified by the descriptor 334, then the preferred operations 600 bypasses step 620 and, instead, directly proceeds to step 622.

After the request for content deliver is made, the mobile device 102 receives the media object of interest from the selected download server at step 624 and, if appropriate, installs the media object to its memory portion 206. The mobile device 102 then sends a confirmation to the central download server and/or the selected download server at step 626, particularly if confirmation (such as an InstallNotifyURI attribute) is specified by the descriptor 334. Thereafter, the preferred operations 600 terminate at step 628.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of a mobile device for communicating wirelessly with content sources having access to media objects, the method comprising:
ascertaining, via a wireless communication link, a download descriptor associated with a media object and including a plurality of server identifiers;
selecting a particular server identifier of the plurality of server identifiers; and
retrieving, via the wireless communication link, the media object from a server associated with the particular server identifier.

2. The method of claim 1, further comprising identifying, via a wireless communication link, a download service provided by servers associated with the server identifiers.

3. The method of claim 2, wherein identifying a download service provided by servers associated with the server identifiers includes finding a markup page that discloses the download service.

4. The method of claim 1, wherein:
ascertaining a download descriptor includes ascertaining the download descriptor stored at a download server; and
retrieving the media object includes retrieving the media object from the download server.

5. The method of claim 1, wherein:
ascertaining a download descriptor includes ascertaining the download descriptor stored at a first server; and
retrieving the media object includes retrieving the media object from a second server different from the first server.

6. The method of claim 1, wherein ascertaining a download descriptor associated with a media object and including a plurality of server identifiers includes selecting a universal resource identifier that points to the download descriptor.

7. The method of claim 1, wherein ascertaining a download descriptor associated with a media object and including a plurality of server identifiers includes selecting the download descriptor including metadata about the media object and instructions regarding retrieval of the media object.

8. The method of claim 1, wherein selecting a particular server identifier of the plurality of server identifiers includes selecting the particular server identifier based on location of the mobile device.

9. The method of claim 1, wherein selecting a particular server identifier of the plurality of server identifiers includes selecting the particular server identifier based on a characteristic of wireless communication link.

10. The method of claim 1, wherein selecting a particular server identifier of the plurality of server identifiers includes selecting the particular server identifier based on a user input of the mobile device.

11. The method of claim 1, wherein selecting a particular server identifier of the plurality of server identifiers includes selecting the particular server identifier based on a predetermined set of rules.

12. The method of claim 1, further comprising reporting, via the wireless communication link, a download status of the media object.

13. A method of one or more servers having access to media objects for communicating wirelessly with a mobile device, the method comprising:
transmitting to the mobile device, via a wireless communication link, a download descriptor associated with a media object and including a plurality of server identifiers;
receiving, via the wireless communication link, a selection of a particular server identifier of the plurality of server identifiers; and
delivering, via the wireless communication link, the media object from a server associated with the particular server identifier.

14. The method of claim 13, further comprising providing a markup page to the mobile device, via the wireless communication link, that discloses download services that may be provided by at least one server.

15. The method of claim 13, further comprising receiving, via the wireless communication link, a request for a download service from the mobile device.

16. The method of claim 13, wherein:
transmitting to the mobile device a download descriptor includes transmitting the download descriptor from a particular server; and
delivering the media object from a server associated with the particular server identifier includes delivering the media object from the particular server.

17. The method of claim 13, wherein:
transmitting to the mobile device a download descriptor includes transmitting the download descriptor from a first server; and
delivering the media object from a server associated with the particular server identifier includes delivering the media object from a second server different from the first server.

18. The method of claim 13, further including receiving from the mobile device a universal resource identifier that points to the download descriptor.

19. The method of claim 13, wherein transmitting to the mobile device a download descriptor associated with a media object and including a plurality of server identifiers includes transmitting the download descriptor including metadata about the media object and instructions regarding retrieval of the media object.

20. The method of claim 13, further comprising receiving, via the wireless communication link, a report including a download status of the media object from the mobile device.

21. A mobile device for communicating wirelessly with content sources having access to media objects comprising:
a wireless transceiver configured to receive a download descriptor associated with a media object and including a plurality of server identifiers; and
a processor configured to select a particular server identifier of the plurality of server identifiers received by the wireless transceiver;
wherein the wireless transceiver retrieves the media object from a server associated with the particular server identifier.

22. The mobile device of claim 21, further comprising a user interface configured to browse a markup page that discloses a download service provided by servers associated with the server identifiers.

23. The mobile device of claim 21, wherein the wireless transceiver receives a download descriptor and retrieves the media object from the same server.

24. The mobile device of claim 21, wherein the wireless transceiver receives a download descriptor and retrieves the media object from different servers.

25. The mobile device of claim 21, wherein the wireless transceiver transmits a universal resource identifier that points to the download descriptor.

26. The mobile device of claim 21, wherein the download descriptor includes metadata about the media object and instructions regarding retrieval of the media object.

27. The mobile device of claim 21, wherein each identifier of the plurality of server identifiers is in the form of a universal resource identifier.

28. The mobile device of claim 21, wherein the download descriptor includes a type attribute of the media object, a size attribute of the media object, and a location identifier indicating a source address of the media object.

29. The mobile device of claim 21, wherein the processor is configured to select the particular server identifier based on location of the mobile device.

30. The mobile device of claim 21, wherein the processor is configured to select the particular server identifier based on a characteristic of wireless communication link.

31. The mobile device of claim 21, wherein the processor is configured to select the particular server identifier based on a user input of the mobile device.

32. The mobile device of claim 21, wherein the processor is configured to select the particular server identifier based on a predetermined set of rules.

33. The mobile device of claim 21, wherein the wireless transceiver reports a download status of the media object.

34. A wireless communication system capable downloading media objects to a mobile device from content sources comprising:
a memory configured to store a download descriptor associated with a media object and including a plurality of server identifiers; and
a network interface configured to transmit to the mobile device, via a wireless communication link, the download descriptor.

35. The wireless communication system of claim 34, wherein the network interface receives, via the wireless communication link, a selection of a particular server identifier of the plurality of server identifiers

36. The wireless communication system of claim 35, wherein the network interface delivers, via the wireless communication link, the media object from a server associated with the particular server identifier.

37. The wireless communication system of claim 34, wherein the network interface provides a markup page to the mobile device, via the wireless communication link, that discloses download services that may be provided by at least one server.

38. The wireless communication system of claim 34, the network interface receives, via the wireless communication link, a request for a download service from the mobile device.

39. The wireless communication system of claim 34, wherein the network interface transmits the download descriptor and provides the media object.

40. The wireless communication system of claim 34, wherein the network interface transmits the download descriptor and a different server provides the media object.

41. The wireless communication system of claim 34, wherein the network interface receives from the mobile device a universal resource identifier that points to the download descriptor.

42. The wireless communication system of claim 34, wherein the download descriptor includes metadata about the media object and instructions regarding retrieval of the media object.

43. The wireless communication system of claim 34, wherein each identifier of the plurality of server identifiers is in the form of a universal resource identifier.

44. The wireless communication system of claim 34, wherein the download descriptor includes a type attribute of the media object, a size attribute of the media object, and a location identifier indicating a source address of the media object.

45. The wireless communication system of claim 34, wherein the network interface receives, via the wireless communication link, a report including a download status of the media object from the mobile device.
